(19) United States
(12) Patent Application Publication
(10) Pub. No.: US 2026/0104123 A1
(43) Pub. Date: Apr. 16, 2026

(54) WATER DIVERTER DEVICE

(71) Applicant: Mark Kennedy, Lakewood, CA (US)

(72) Inventor: Mark Kennedy, Lakewood, CA (US)

(21) Appl. No.: 18/916,126

(22) Filed: Oct. 15, 2024

(51) Int. Cl. F16L 55/07; B60D 1/52; B60R 9/06

(52) U.S. Cl. CPC F16L 55/07; B60D 1/52; B60R 9/06

(57) ABSTRACT

A water diverter device for includes a hitch receiver that is attachable to a rear end of a vehicle. An angled member is releasably matable to the hitch receiver thereby enabling the angled member to extend rearwardly from the rear end of the vehicle. The angled member extends over an open fire hydrant when the vehicle is parked on a roadway adjacent to a location of the open fire hydrant. A terminal member is matable to the angled member and a diverter plate is attached to the terminal member. The diverter plate is positioned over the open fire hydrant to divert water spraying upwardly from the open fire hydrant into a lateral flow. In this way the water spraying upwardly does not rain down upon a service worker.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to diverter devices and more particularly pertains to a new diverter device for diverting water spraying upwardly from an open fire hydrant into a lateral flow. The device includes an angled member that is matable to a hitch receiver on a vehicle to enable the angled member to extend over an open fire hydrant when the vehicle is parked on a roadway. The device includes a terminal member that is matable to the angled member and a diverter plate that is attached to the terminal member. The diverter plate diverts water straying upwardly from the open fire hydrant into a lateral flow to inhibit the water from raining down onto a service worker.

### (2) Description of Related Art Including Information Disclosed Under 37 CFR 1.97 and 1.98.

The prior art relates to diverter devices including: a fire hydrant safety device that includes a box which is positionable around a fire hydrant which has a plurality of strategically positioned holes to align with outputs of the fire hydrant and a lid that is attachable to the box; a game hanger device that includes a frame which is attachable to hitch receiver of a vehicle and a hanger attached to the frame that is elevated over the vehicle for suspending a game animal in a vertical orientation for dressing the game animal. In no instance does the prior art disclose a diverter device that includes an angled member that is matable to a hitch receiver of a vehicle which angles laterally away from the vehicle and a terminal member that is matable to the angled member and to enable the terminal member to extend over an open fire hydrant when the vehicle is parked near the open fire hydrant and a diverter plate attached to the terminal member to divert water spraying upwardly from the open fire hydrant into a lateral flow.

### BRIEF SUMMARY OF THE INVENTION

An embodiment of the disclosure meets the needs presented above by generally comprising a hitch receiver that is attachable to a rear end of a vehicle. An angled member is releasably matable to the hitch receiver thereby enabling the angled member to extend rearwardly from the rear end of the vehicle. The angled member extends over an open fire hydrant when the vehicle is parked on a roadway adjacent to a location of the open fire hydrant. A terminal member is matable to the angled member and a diverter plate is attached to the terminal member. The diverter plate is positioned over the open fire hydrant to divert water spraying upwardly from the open fire hydrant into a lateral flow. In this way the water spraying upwardly does not rain down upon a service worker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a water diverter device according to an embodiment of the disclosure.

FIG. 2 is a top view of an embodiment of the disclosure.

FIG. 3 is a bottom view of a diverter plate and a terminal member of an embodiment of the disclosure.

FIG. 4 is a left side view of a diverter plate and a terminal member of an embodiment of the disclosure.

FIG. 5 is a front phantom view of a diverter plate and a terminal member of an embodiment of the disclosure.

FIG. 6 is a back view of a diverter plate and a terminal member of an embodiment of the disclosure.

FIG. 7 is a top in-use view of an embodiment of the disclosure showing an angled member being mated to a hitch receiver of a vehicle and a terminal member mated to the angled member.

FIG. 8 is a perspective in-use view of an embodiment of the disclosure showing a diverter plate diverting water spraying upwardly from an open fire hydrant into a lateral flow.

### DETAILED DESCRIPTION OF THE INVENTION

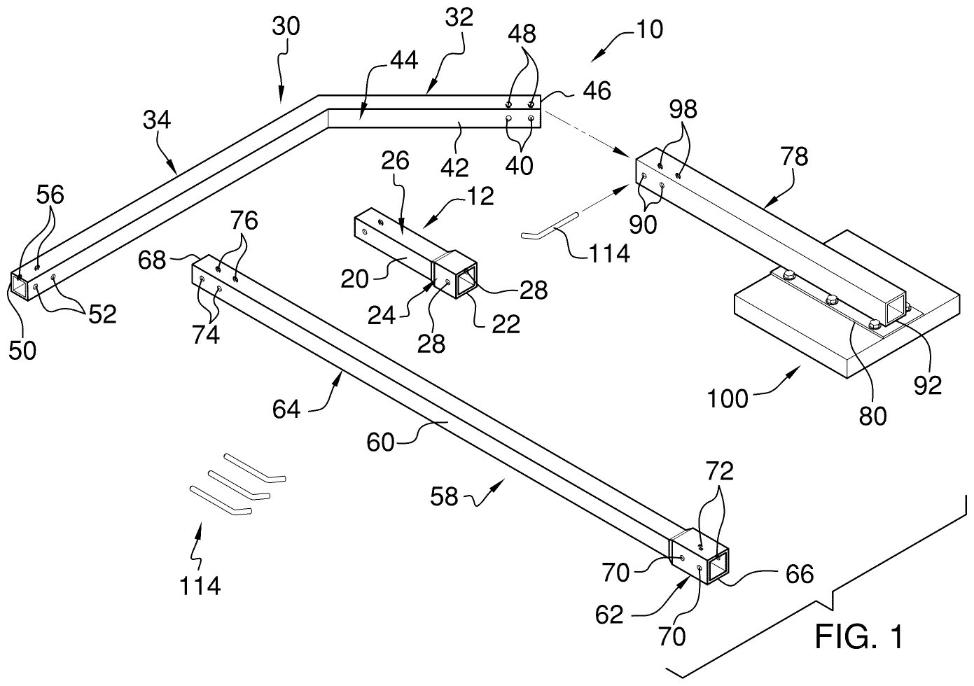

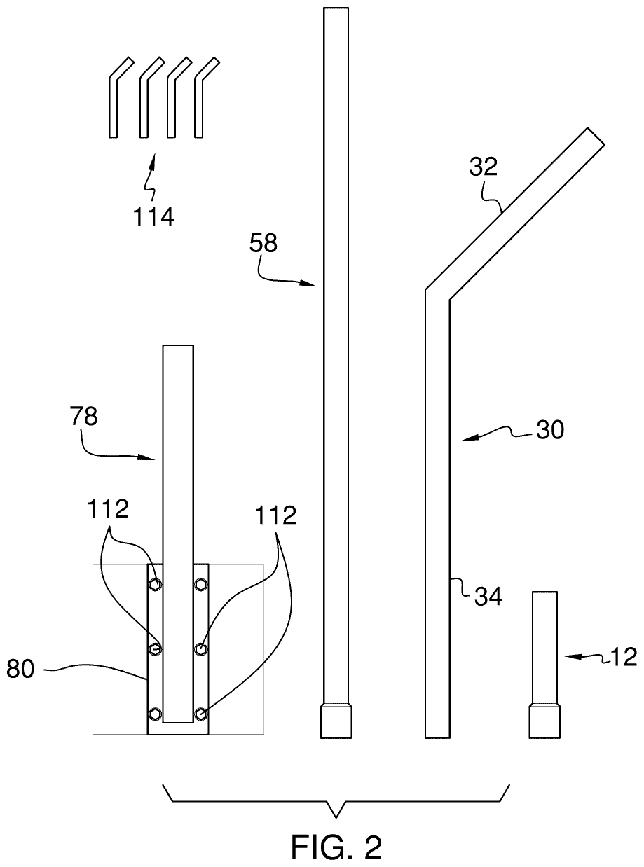

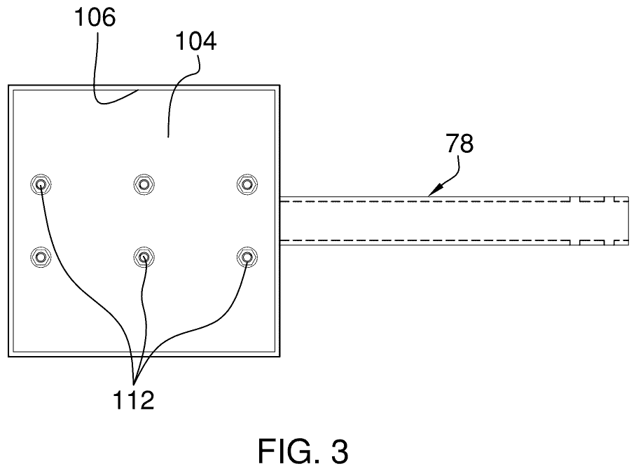

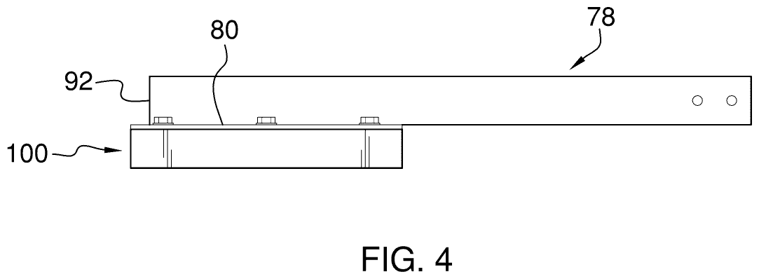

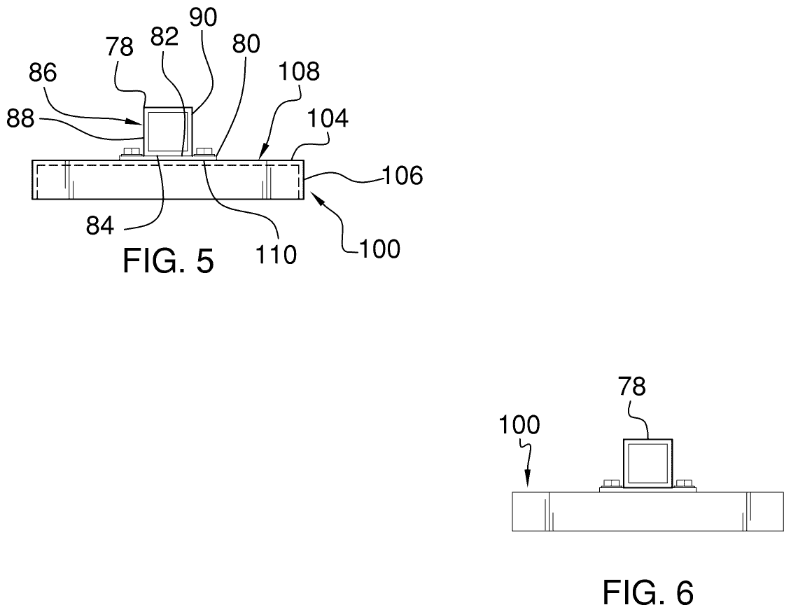

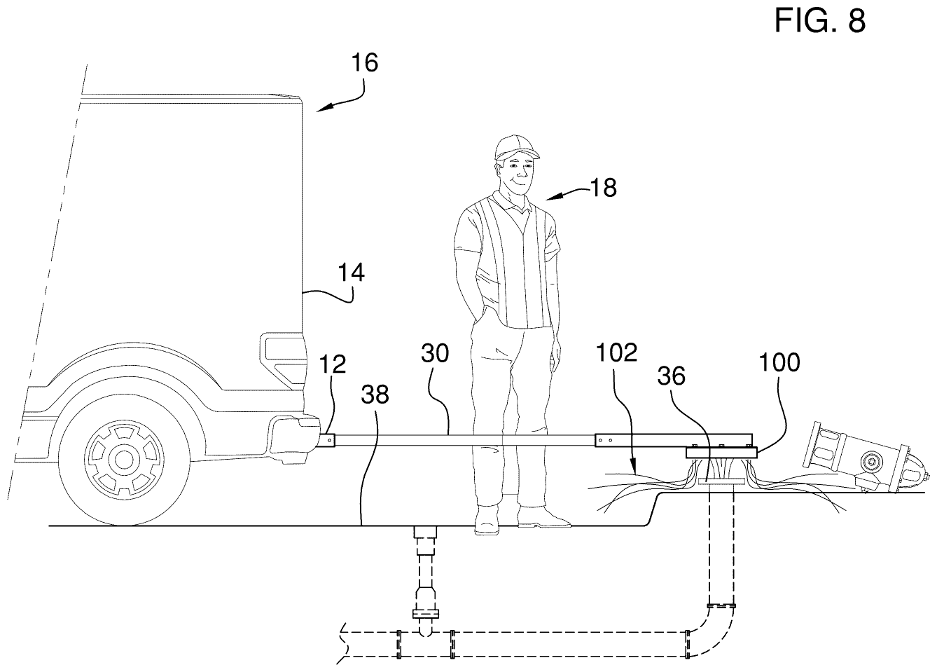

With reference now to the drawings, and in particular to FIGS. 1 through 8 thereof, a new diverter device embodying the principles and concepts of an embodiment of the disclosure and generally designated by the reference numeral 10 will be described.

As best illustrated in FIGS. 1 through 8, the water diverter device 10 generally comprises a hitch receiver 12 that is attachable to a rear end 14 of a vehicle 16. The vehicle 16 may be a service vehicle that is driven on public roadways which is driven by a service worker 18 who services fire hydrants or other municipal water 102 equipment. The hitch receiver 12 has an outer wall 20 and a primary end 22 and the outer wall 20 has a first section 24 which has a perimeter that is greater that a perimeter of a second section 26. The first section 24 is associated with the primary end 22 and the first section 24 has a length which is less than a length of the second section 26. The outer wall 20 has a pair of holes 28 each extending through the first section 24 on opposite sides of the first section 24 with respect to each other. The primary end 22 is open and the hitch receiver 12 is oriented on the vehicle 16 such that the primary end 22 is directed away from the rear end 14 of the vehicle 16 thereby enabling the primary end 22 to be accessible.

An angled member 30 is provided which is releasably matable to the hitch receiver 12 thereby enabling the angled member 30 to extend rearwardly from the rear end 14 of the vehicle 16. The angled member 30 has a primary section 32 which is oriented at an obtuse angle with a secondary section 34 and the secondary section 34 has a length which is greater than a length of the primary section 32. The primary section 32 is matable to the hitch receiver 12 having the secondary section 34 angling laterally with respect to the rear end 14 of the vehicle 16. In this way the secondary section 34 of the angled member 30 can extend over an open fire hydrant 36 when the vehicle 16 is parked on a roadway 38 adjacent to a location of the open fire hydrant 36.

The angled member 30 has a pair of first holes 40 each extending through a first side 42 of an exterior wall 44 of the primary section 32 and each of the pair of first holes 40 is located proximate to a first end 46 of the angled member 30. The angled member 30 has a pair of second holes 48 each extending through a second side 50 of the exterior wall 44 of the primary section 32 such that each of the pair of second holes 48 is aligned with a respective one of the pair of first holes 40. The angled member 30 has a pair of third holes 52 each extending through the first side 42 of the exterior wall 44 of the secondary section 34 and each of the pair of third holes 52 is located proximate to a second end 54 of the angled member 30. Additionally, the angled member 30 has a pair of fourth holes 56 each extending through the second side 50 of the exterior wall 44 of the secondary section 34 such that each of the pair of fourth holes 56 is aligned with a respective one of the pair of third holes 52. The first end 46 is insertable into the primary end 22 of the hitch receiver 12 thereby enabling a respective one of the pair of holes 28 in the outer wall 20 of the hitch receiver 12 to be aligned with a respective one of the pair of first holes 40 and enabling a respective one of the pair of holes 28 in the outer wall 20 of the hitch receiver 12 to be aligned with a respective one of the pair of second holes 48.

An extension member 58 is provided and the extension member 58 is releasably matable to the angled member 30 thereby increasing a total length of the extension member 58 and the angled member 30 to a maximum length. The extension member 58 is matable to the secondary section 34 of the angled member 30 to enable the extension member 58 to extend over the open fire hydrant 36 when a distance between the open fire hydrant 36 and the roadway 38 is greater than a length of the secondary section 34 of the angled member 30. The extension member 58 has an outside wall 60 which has a first section 62 that has a perimeter which is greater than a perimeter of a second section 64 of the outside wall 60 and the first section 62 of the outside wall 60 has a length which is less than a length of the second section 64 of the outside wall 60. The first section 62 of the outside wall 60 is associated with a first end 66 of the extension member 58 and the second section 64 of the outside wall 60 is associated with a second end 68 of the extension member 58. Additionally, each of the first end 66 and the second end 68 of the extension member 58 is open.

The extension member 58 has a pair of primary holes 70 each extending through the first section 62 of the outside wall 60 and the extension member 58 has a pair of secondary holes 72 each extending through the first section 62 of the outside wall 60. Each of the pair of secondary holes 72 is aligned with a respective one of the primary holes 70. Additionally, the extension member 58 has a pair of tertiary holes 74 each extending through the second section 64 of the outside wall 60 and the extension member 58 has a pair of quaternary holes 76 each extending through the second section 64 of the outside wall 60. Each of the pair of quaternary holes 76 is aligned with a respective one of the tertiary holes 74. The first end of the extension member 58 insertably receives the second end 54 of the angled member 30 having each of the pair of primary holes 70 being aligned with a respective one of the pair of third holes 52 in the first side 42 of the exterior wall 44 of the second section 26 of the angled member 30 and having each of the pair of secondary holes 72 being aligned with a respective one of the pair of fourth holes 56 in the second side 50 of the exterior wall 44 of the second section 26 of the angled member 30.

A terminal member 78 is provided and the terminal member 78 is matable to either the angled member 30 or the extension member 58 when the extension member 58 is mated to the angled member 30. The terminal member 78 includes a mounting plate 80 which has a top surface 82 that is coupled to a bottom side 84 of an outer wall 86 of the terminal member 78 such that the mounting plate 80 extends laterally beyond each of a first lateral side 88 and a second lateral side 90 of the outer wall 86 of the terminal member 78. The mounting plate 80 extends outwardly beyond a first end 92 of the terminal member 78 and the mounting plate 80 extends toward a second end 94 of the terminal member 78. The outer wall 86 of the terminal member 78 has a pair of first openings 96 each extending through the first lateral side 88 of the outer wall 86 of the terminal member 78 at a point located proximate the second end 94 of the terminal member 78. Additionally, the outer wall 86 of the terminal member 78 has a pair of second openings 98 each extending through the second lateral side 90 of the outer wall 86 of the terminal member 78 at a point located proximate the second end 94 of the terminal member 78.

The outer wall 86 of the terminal member 78 has a perimeter which is greater than a perimeter of the second section 64 of the outside wall 60 of the extension member 58 thereby enabling the second end 94 of the terminal member 78 to insertably receive the second end 68 of the extension member 58 when the extension member 58 is mated to the angled member 30. In this way each of the pair of first openings 96 can be aligned with a respective one of the pair of the tertiary holes 74 in the second section 64 of the outside wall 60 of the extension member 58 and each of the pair of second openings 98 can be aligned with a respective one of the pair of quaternary holes 76 in the second section 64 of the outside wall 60 of the extension member 58. The perimeter of the outer wall 86 of the terminal member 78 is greater than a perimeter of the exterior wall 44 of the angled member 30 thereby enabling the second end 94 of the terminal member 78 to insertably receive the second end 54 of the angled member 30. In this way each of the pair of first openings 96 can be aligned with a respective one of the pair of third holes 52 in the first side 42 of the exterior wall 44 of the second section 26 and each of the pair of second openings 98 can be aligned with a respective one of the pair of fourth holes 56 in the second side 50 of the exterior wall 44 of the second section 26 when the extension member 58 is not mated to the angled member 30.

A diverter plate 100 is attached to the terminal member 78 thereby enabling the diverter plate 100 to be positioned over the open fire hydrant 36. In this way the diverter plate 100 can divert water 102 spraying upwardly from the open fire hydrant 36 into a lateral flow to inhibiting the water 102 spraying upwardly from the open fire hydrant 36 from raining down upon the service worker 18 when the service worker 18 is servicing the open fire hydrant 36. In this way the service worker 18 can stay relatively dry while the service worker 18 is performing service on the open fire hydrant 36.

The diverter plate 100 has a top wall 104 and a perimeter wall 106 extending downwardly from the top wall 104. An upper surface 108 of the top wall 104 abuts a bottom surface 110 of the mounting plate 80 on the terminal member 78 having the mounting plate 80 being centrally located on the diverter plate 100. In this way the perimeter wall 106 of the diverter plate 100 inhibits the water 102 spraying against the top wall 104 of the diverter plate 100 from spraying around the top wall 104 and being directed upwardly. Furthermore, the diverter plate 100 is comprised of a fluid impermeable and rigid material, including but not being limited to stainless steel or aluminum. In this way the diverter plate 100 can resist being deformed by the force of the water 102 spraying against the diverter plate 100 as well as being corrosion resistant. A plurality of fasteners 112 is provided and each of the plurality of fasteners 112 extends through the mounting plate 80 and engages the diverter plate 100 for attaching the diverter plate 100 to the mounting plate 80. The diverter plate 100 has a length and a width ranging between approximately 35.0 cm and 45.0 cm and the perimeter wall 106 has a height ranging between approximately 5.0 cm and 10.0 cm. Additionally, the plurality of fasteners 112 may comprise nuts and bolts or other types of threaded fastener.

A plurality of pins 114 is provided and a respective one of the plurality pins 114 can be extended through the hitch receiver 12 and the angled member 30 for securing the angled member 30 to the hitch receiver 12. A respective pair of the plurality of pins 114 can each be extended through the extension member 58 and the angled member 30 to secure the extension member 58 to the angled member 30 if need be. Additionally, a respective pair of the pins 114 can each be extended through the terminal member 78 and either the extension member 58 or the angled member 30, depending on whether or not the extension member 58 is mated to the angled member 30, for securing terminal member 78 to either the extension member 58 or the angled member 30.

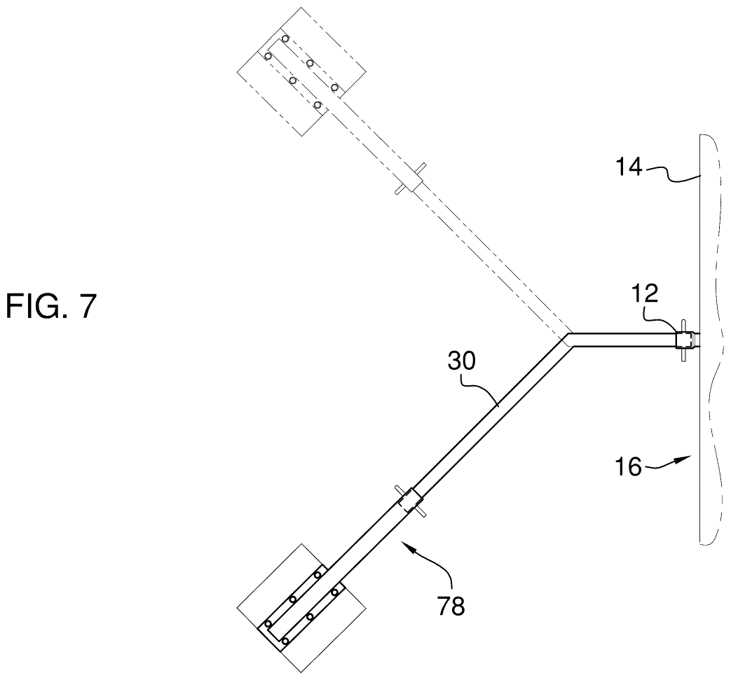

In use, the angled member 30 is inserted into the hitch receiver 12 and the terminal member 78 is mated to the angled member 30. As is shown in FIG. 7, the angled member 30 can be oriented to extend either to the left or to the right of the vehicle 16, depending on the location of the open fire hydrant 36 with respect to the vehicle 16. The vehicle 16 is backed up along the roadway 38 until the diverter plate 100 is positioned over the open fire hydrant 36. In this way the diverter plate 100 diverts the water 102 flowing from the open fire hydrant 36 from a vertical flow into a lateral flow. Thus, the water 102 does not rain down upon the service worker 18 while the service worker 18 is attempting to shut off the open fire hydrant 36 thereby enabling the service worker 18 to remain relatively dry. The extension member 58 is mated to the angled member 30 when the angled member 30 does not have sufficient length to reach the open fire hydrant 36. The terminal member 78 is mated to the extension member 58 to enable the diverter plate 100 to be positioned over the open fire hydrant 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water diverter device for attaching to a hitch receiver of a vehicle to enable water spraying from an open fire hydrant to be diverted thereby enabling a worker to remain dry while attempting to shut off the fire hydrant, said device comprising:
a hitch receiver being attachable to a rear end of a vehicle;
an angled member being releasably matable to said hitch receiver thereby enabling said angled member to extend rearwardly from said rear end of said vehicle, said angled member having a primary section being oriented at an obtuse angle with a secondary section, said secondary section having a length being greater than a length of said primary section, said primary section being matable to said hitch receiver having said secondary section angling laterally with respect to said rear end of said vehicle wherein said secondary section of said angled member is configured to extend over an open fire hydrant when said vehicle is parked on a roadway adjacent to a location of the open fire hydrant;
an extension member being releasably matable to said angled member thereby increasing a total length of said extension member and said angled member to a maximum length, said extension member being matable to said secondary section of said angled member wherein said angled member is configured to extend over the open fire hydrant when a distance between the fire hydrant and the roadway is greater than a length of said secondary section of said angled member;
a terminal member being matable to either said angled member or said extension member when said extension member is mated to said angled member; and
a diverter plate being attached to said terminal member wherein said diverter plate is configured to be positioned over the open fire hydrant thereby enabling said diverter plate to divert water spraying upwardly from the open fire hydrant into a lateral flow for inhibiting the water spraying upwardly from the open fire hydrant from raining down upon a service worker when the service worker is servicing the open fire hydrant.

2. The water diverter device according to claim 1, wherein:
said hitch receiver has an outer wall and a primary end;
said outer wall has a first section which has a perimeter being greater that a perimeter of a second section;
said first section is associated with said primary end;
said first section has a length being less than a length of said second section;
said outer wall has a pair of holes each extending through said first section on opposite sides of said first section with respect to each other;
said primary end is open;
said hitch receiver is oriented on said vehicle such that said primary end is directed away from said rear end of said vehicle thereby enabling said primary end to be accessible;
said angled member has a pair of first holes each extending through a first side of an exterior wall of said primary section;
each of said pair of first holes is located proximate to a first end of said angled member;
said angled member has a pair of second holes each extending through a second side of said exterior wall of said primary section such that each of said pair of second holes is aligned with a respective one of said pair of first holes; and
said first end is insertable into said primary end of said hitch receiver thereby enabling a respective one of said pair of holes in said outer wall of said hitch receiver to be aligned with a respective one of said pair of first holes and enabling a respective one of said pair of holes in said outer wall of said hitch receiver to be aligned with a respective one of said pair of second holes.

3. The water diverter device according to claim 1, wherein:
said angled member has a pair of first holes and a pair of second holes and a first end;
said angled member has a pair of third holes each extending through a first side of an exterior wall of said secondary section;
each of said pair of third holes is located proximate to a second end of said angled member;
said angled member has a pair of fourth holes each extending through a second side of said exterior wall of said secondary section such that each of said pair of fourth holes is aligned with a respective one of said pair of third holes;
said extension member has an outside wall which has a first section that has a perimeter being greater than a perimeter of a second section;
said first section of said outside wall has a length being less than a length of said second section of said outside wall;
said first section of said outside wall is associated with a first end of said extension member;
said second section of said outside wall is associated with a second end of said extension member;
each of said first end and said second end of said extension member is open;
said extension member has a pair of primary holes each extending through said first section of said outside wall;
said extension member has a pair of secondary holes each extending through said first section of said outside wall;
each of said pair of secondary holes is aligned with a respective one of said primary holes;
said extension member has a pair of tertiary holes each extending through said second section of said outside wall;
said extension member has a pair of quaternary holes each extending through said second section of said outside wall;
each of said pair of quaternary holes is aligned with a respective one of said tertiary holes; and
said first end of said extension member insertably receives said second end of said angled member having each of said pair of primary holes being aligned with a respective one of said pair of third holes in said first side of said exterior wall of said second section of said angled member and having each of said pair of secondary holes being aligned with a respective one of said pair of fourth holes in said second side of said exterior wall of said second section of said angled member.

4. The water diverter device according to claim 1, wherein:
said terminal member includes a mounting plate which has a top surface being coupled to a bottom side of an outer wall of said terminal member such that said mounting plate extends laterally beyond each of a first lateral side and a second lateral side of said outer wall of said terminal member;
said mounting plate extends outwardly beyond a first end of said terminal member; and
said mounting plate extends toward a second end of said terminal member.

5. The water diverter device according to claim 3, wherein:
said terminal member has a first end and a second end and an outer wall extending between said first end and said second end of said terminal member;
said outer wall of said terminal member has a pair of first openings each extending through a first lateral side of said outer wall of said terminal member at a point located proximate said second end of said terminal member;
said outer wall of said terminal member has a pair of second openings each extending through said second lateral side of said outer wall of said terminal member at a point located proximate said second end of said terminal member; and
said outer wall of said terminal member has a perimeter being greater than a perimeter of said second section of said outside wall of said extension member thereby enabling said second end of said terminal member to insertably receive said second end of said extension member when said extension member is mated to said angled member thereby enabling each of said pair of first openings to be aligned with a respective one of said pair of said tertiary holes in said second section of said outside wall of said extension member and having said pair of second openings being aligned with a respective one of said pair of quaternary holes in said second section of said outside wall of said extension member.

6. The water diverter device according to claim 3, wherein:
said terminal member has a first end and a second end and an outer wall extending between said first end and said second end of said terminal member;
said outer wall of said terminal member has a pair of first openings each extending through a first lateral side of said outer wall of said terminal member at a point located proximate said second end of said terminal member;
said outer wall of said terminal member has a pair of second openings each extending through said second lateral side of said outer wall of said terminal member at a point located proximate said second end of said terminal member; and
said perimeter of said outer wall of said terminal member is greater than a perimeter of said exterior wall of said angled member thereby enabling said second end of said terminal member to insertably receive said second end of said angled member thereby enabling each of said pair of first openings to be aligned with a respective one of said pair of third holes in said first side of said exterior wall of said second section and having each of said pair of second openings being aligned with a respective one of said pair of fourth holes in said second side of said exterior wall of said second section when said extension member is not mated to said angled member.

7. The water diverter device according to claim 4, wherein:
said diverter plate has a top wall and a perimeter wall extending downwardly from said top wall;
an upper surface of said top wall abuts a bottom surface of said mounting plate on said terminal member having said mounting plate being centrally located on said diverter plate wherein said perimeter wall of said diverter plate is configured to inhibit the water spraying against said top wall of said diverter plate from spraying around said top wall and being directed upwardly;
said water diverter device includes a plurality of fasteners; and
each of said plurality of fasteners extends through said mounting plate and engaging said diverter plate for attaching said diverter plate to said mounting plate.

8. A water diverter device for attaching to a hitch receiver of a vehicle to enable water spraying from an open fire hydrant to be diverted thereby enabling a worker to remain dry while attempting to shut off the fire hydrant, said device comprising:
a hitch receiver being attachable to a rear end of a vehicle, said hitch receiver having an outer wall and a primary end, said outer wall having a first section which has a perimeter being greater that a perimeter of a second section, said first section being associated with said primary end, said first section having a length being less than a length of said second section, said outer wall having a pair of holes each extending through said first section on opposite sides of said first section with respect to each other, said primary end being open, said hitch receiver being oriented on said vehicle such that said primary end is directed away from said rear end of said vehicle thereby enabling said primary end to be accessible;
an angled member being releasably matable to said hitch receiver thereby enabling said angled member to extend rearwardly from said rear end of said vehicle, said angled member having a primary section being oriented at an obtuse angle with a secondary section, said secondary section having a length being greater than a length of said primary section, said primary section being matable to said hitch receiver having said secondary section angling laterally with respect to said rear end of said vehicle wherein said secondary section of said angled member is configured to extend over an open fire hydrant when said vehicle is parked on a roadway adjacent to a location of the open fire hydrant, said angled member having a pair of first holes each extending through a first side of an exterior wall of said primary section, each of said pair of first holes being located proximate to a first end of said angled member, said angled member having a pair of second holes each extending through a second side of said exterior wall of said primary section such that each of said pair of second holes is aligned with a respective one of said pair of first holes, said angled member having a pair of third holes each extending through said first side of said exterior wall of said secondary section, each of said pair of third holes being located proximate to a second end of said angled member, said angled member having a pair of fourth holes each extending through said second side of said exterior wall of said secondary section such that each of said pair of fourth holes is aligned with a respective one of said pair of third holes, said first end being insertable into said primary end of said hitch receiver thereby enabling a respective one of said pair of holes in said outer wall of said hitch receiver to be aligned with a respective one of said pair of first holes and enabling a respective one of said pair of holes in said outer wall of said hitch receiver to be aligned with a respective one of said pair of second holes;
an extension member being releasably matable to said angled member thereby increasing a total length of said extension member and said angled member to a maximum length, said extension member being matable to said secondary section of said angled member wherein said angled member is configured to extend over the open fire hydrant when a distance between the fire hydrant and the roadway is greater than a length of said secondary section of said angled member, said extension member having an outside wall which has a first section that has a perimeter being greater than a perimeter of a second section, said first section of said outside wall having a length being less than a length of said second section of said outside wall, said first section of said outside wall being associated with a first end of said extension member, said second section of said outside wall being associated with a second end of said extension member, each of said first end and said second end of said extension member being open, said extension member having a pair of primary holes each extending through said first section of said outside wall, said extension member having a pair of secondary holes each extending through said first section of said outside wall, each of said pair of secondary holes being aligned with a respective one of said primary holes, said extension member having a pair of tertiary holes each extending through said second section of said outside wall, said extension member having a pair of quaternary holes each extending through said second section of said outside wall, each of said pair of quaternary holes being aligned with a respective one of said tertiary holes, said first end of said extension member insertably receiving said second end of said angled member having each of said pair of primary holes being aligned with a respective one of said pair of third holes in said first side of said exterior wall of said second section of said angled member and having each of said pair of secondary holes being aligned with a respective one of said pair of fourth holes in said second side of said exterior wall of said second section of said angled member;
a terminal member being matable to either said angled member or said extension member when said extension member is mated to said angled member, said terminal member including a mounting plate which has a top surface being coupled to a bottom side of an outer wall of said terminal member such that said mounting plate extends laterally beyond each of a first lateral side and a second lateral side of said outer wall of said terminal member, said mounting plate extending outwardly beyond a first end of said terminal member, said mounting plate extending toward a second end of said terminal member, said outer wall of said terminal member having a pair of first openings each extending through said first lateral side of said outer wall of said terminal member at a point located proximate said second end of said terminal member, said outer wall of said terminal member having a pair of second openings each extending through said second lateral side of said outer wall of said terminal member at a point located proximate said second end of said terminal member, said outer wall of said terminal member having a perimeter being greater than a perimeter of said second section of said outside wall of said extension member thereby enabling said second end of said terminal member to insertably receive said second end of said extension member when said extension member is mated to said angled member thereby enabling each of said pair of first openings to be aligned with a respective one of said pair of said tertiary holes in said second section of said outside wall of said extension member and having said pair of second openings being aligned with a respective one of said pair of quaternary holes in said second section of said outside wall of said extension member, said perimeter of said outer wall of said terminal member being greater than a perimeter of said exterior wall of said angled member thereby enabling said second end of said terminal member to insertably receive said second end of said angled member thereby enabling each of said pair of first openings to be aligned with a respective one of said pair of third holes in said first side of said exterior wall of said second section and having each of said pair of second openings being aligned with a respective one of said pair of fourth holes in said second side of said exterior wall of said second section when said extension member is not mated to said angled member;
a diverter plate being attached to said terminal member wherein said diverter plate is configured to be positioned over the open fire hydrant thereby enabling said diverter plate to divert water spraying upwardly from the open fire hydrant into a lateral flow for inhibiting the water spraying upwardly from the open fire hydrant from raining down upon a service worker when the service worker is servicing the open fire hydrant, said diverter plate having a top wall and a perimeter wall extending downwardly from said top wall, an upper surface of said top wall abutting a bottom surface of said mounting plate on said terminal member having said mounting plate being centrally located on said diverter plate wherein said perimeter wall of said diverter plate is configured to inhibit the water spraying against said top wall of said diverter plate from spraying around said top wall and being directed upwardly; and
a plurality of fasteners, each of said plurality of fasteners extending through said mounting plate and engaging said diverter plate for attaching said diverter plate to said mounting plate.
